(19) United States
(12) Patent Application Publication
(10) Pub. No.: US 2023/0320369 A1
(43) Pub. Date: Oct. 12, 2023

(54) APPARATUS AND METHOD FOR PROCESSING OF POULTRY PARTS

(71) Applicant: Foodmate US, LLC, Ball Ground, GA (US)

(72) Inventor: Marvin Trayler, Ball Ground, GA (US)

(21) Appl. No.: 18/194,831

(22) Filed: Apr. 3, 2023

Related U.S. Application Data
(60) Provisional application No. 63/329,528, filed on Apr. 11, 2022.

(51) Int. Cl. A22C 21/00

(52) U.S. Cl. CPC A22C 21/0023; A22C 21/0053

(57) ABSTRACT

An apparatus and method for processing poultry leg or drum parts to form “Drum Tulip” products. A conveyer includes drum holder assemblies each configured to receive and carry a leg or drum part along a processing path through a cutting station and to a discharge. The cutting station includes cutting assemblies on opposite sides of the processing path for separating kneecap and knuckle portions from the leg or drum parts to form the drum tulip products. Each of the drum holder assemblies includes a base having a clamping recess and a pivoting clamp arm having a clamping portion adapted to cooperatively engage with the clamping recess to at least partially define a meat-stripping passage through which a portion of a leg or drum part is held. A meat scraper is configured to push at least a portion of the leg or drum part at least partially through the meat-stripping passage.

### CROSS-REFERENCE

The present patent application claims benefit of U.S. Provisional Patent Application No. 63/329,528, filed Apr. 11, 2022.

### INCORPORATED BY REFERENCE

The disclosure of U.S. Provisional Patent Application No. 63/329,528, filed Apr. 11, 2022, is specifically incorporated by reference herein as if set forth in its entirety.

### TECHNICAL FIELD

The present disclosure generally relates to an apparatus and method for processing animal parts, and in particular, to an apparatus for cutting a poultry leg of drum part to remove a portion of the hock and kneecap therefrom for forming a poultry Drum Tulip product.

### BACKGROUND

The processing of animal parts such as poultry has become increasingly automated to provide increases in production rates and greater efficiencies and consistency in the resultant products. Some operations for cut-up of various animal parts, however, still involve largely manual operations; and in addition, as world-wide consumer preferences and demands for different products change, increases in demands for such newer and/or different products often can lead to a need for development of further automated processing equipment. For example, “Drum Tulip” products formed from the legs or drums of poultry recently have become popular, which products previously have been produced by hand, involving one or more workers manually handling and cutting portions of poultry legs to form such Drum Tulip products. Such manual processing operations understandably are time consuming and very labor intensive, and further create issues with consistency of the resultant Drum Tulip products.

Therefore, it can be seen that a need exists for an apparatus and method for processing animal parts, such as poultry legs or drums, to form Drum Tulip products in a substantially automated manner. It is to these and other related and unrelated problems and needs in the art that the present disclosure is directed.

### SUMMARY

The present disclosure generally is directly to an apparatus and methods for processing animal parts, and in embodiments, is directed to an apparatus and method for processing the leg or drum parts of poultry to form “Drum Tulip” products.

According to some aspects, the apparatus includes a frame along which a conveyer is supported. The conveyer includes a series of drum holder assemblies arranged at spaced intervals therealong. Each of the drum holder assemblies is configured to receive and carry a poultry leg or drum part along a processing path from a loading area through a cutting station or area and to a discharge. As the leg or drum parts are moved along the processing path through the cutting station or area, a kneecap portion and at least a portion of the knuckle of the leg bone of each leg or drum part will be separated therefrom to form a Drum Tulip product. The Drum Tulip products thereafter will be discharged from their respective associated drum holder assemblies, with the empty drum holder assemblies continuing along a return portion of the conveyer back to the loading area.

In an embodiment, each of the drum holder assemblies will include a base carriage having a cradle including a seat or rest portion configured to support the drum or leg and a clamping recess through which the hock end of the leg or drum part is extended. A pivoting clamp arm is attached to the base along a rear side thereof and can include a first or proximal end having a generally semicircular clamping portion adapted to fit over and cooperatively engage with the clamping recess of the cradle. The clamping portion of the clamp arm and the clamping recess define a meat-stripping passage through which a portion of a leg or drum part extends and is held as the leg or drum part is moved along the processing path through the downstream cutting area or station by the conveyer.

A cam can be provided at the second or distal end of the clamp arm and will be moved into engagement with a cam surface upstream of the cutting area or station as the drum holding assembly is conveyed along the processing path. As the cam engages and moves along the cam surface, the clamp arm is caused to pivot toward engagement with a portion of a leg or a drum part received within the clamping recess of the cradle so as to clamp and hold the leg or drum part on its drum holding assembly.

In embodiments, the frame can be configured to accommodate and provide different size loading areas. For example, in embodiments, the frame can be configured to include a loading area of a sufficient size to enable one to three workers (or possibly more) to load leg or drum parts into the drum holding assemblies can be provided.

The cutting station or area is located downstream of the loading area, and can include first and second cutting assemblies mounted on opposite sides of the conveyer. Each of the first and second cutting assemblies generally will include a cutting blade, which can include a rotary cutting blade driven by a motor, although other types of cutters also can be used. The first cutting assembly generally will be arranged upstream of the second cutting assembly and will be positioned to cut at least a portion of the kneecap from the leg or drum part. The second cutting assembly generally will be located downstream from the first cutting assembly, being arranged along the processing path so as to engage and cut away at least a portion of the back end, e.g. at least a portion of the knuckle of the leg bone of the leg or drum part.

In embodiments, front and rear guides will be provided adjacent the first and second cutting assemblies. The front guide can include one or more guide bars or plates configured to support and guide the leg or drum part so as to locate the kneecap portion thereof in alignment or substantially in alignment with the cutting blade of the first cutting assembly for separation of the kneecap portion therefrom. The front guide further can include a meat scraper, which can comprise a plate or bracket configured to engage and urge the leg bone of the leg or drum part through the meat-stripping passage defined between the clamping portion of the clamp arm and the clamping recess of cradle of its drum holding assembly. This causes the knuckle of the leg bone to be moved toward a selected desired alignment for cutting the knuckle therefrom, and at the same time causes a portion of the meat of the leg or drum part adjacent the knuckle to be stripped and pushed along the leg bone and away from the knuckle to as to create a space defining a handle portion for the Drum Tulip product after cutting of the knuckle therefrom. In embodiments, the meat scraper can be at least partially downstream from the second cutting assembly. The rear guide generally will include a ramp having the cam surface engaged by the cams of the clamp arms of the drum holding assemblies for moving the clamp arms into clamping engagement with the leg or drum part seated therein; and one or more guide rails or plates configured to further help guide and support the leg or drum part during separation of the knuckle therefrom.

In addition, the apparatus can include a controller mounted along the frame, and which can include one or more processors configured with programming to control the motors for driving the conveyer and driving the cutting blades of the cutting assemblies. The controller can monitor and communicate with a series of sensors to detect jams or misfeeding of the leg or drum part, or other fault conditions, and can stop the continued operation of the apparatus as needed. For example, the controller can monitor one or more safety stop sensors, such as a safety arm, blade cover sensors that detect removal of protective covers from the cutting blades, and/or other sensors that can be engaged by misaligned leg or drum, e.g. causing a sensor to be tripped or to be broken, whereupon the controller can stop further operation of the apparatus.

In other aspects, a method is provided wherein poultry leg or drum, each including a drumstick with a hock end portion and a leg bone having a knuckle end extending therethrough, and a kneecap portion, will be loaded into cradles of each of a series of drum holding assemblies being conveyed along a processing path. As the drum holding assemblies are moved along the processing path, the leg bones of the leg or drum parts are captured between a clamping portion of a clamp arm and a corresponding clamping recess of the cradle of their corresponding drum holding assembles.

The legs or drum parts are moved into and through a first cutting assembly, passing into engagement with a cutting blade that cuts a portion of the kneecap therefrom. Thereafter, as the leg or drum parts continue along the processing path, they can be guided and urged in a substantially transverse direction, across the processing path, by a meat scraper of a front guide. This can cause the leg bone of the leg or drum part to be urged through the meat-stripping passage defined between the clamping portion of the clamp arm and the corresponding clamping recess of the cradle of each drum holding assembly. As a result, the leg bone is extended or projected to a position for cutting the knuckle away from the leg bone. At the same time, at least a portion of the meat of the leg or drum part will be stripped and pushed or urged along the leg bone so as to create a space between the meat and the end of the leg bone to define a handle part for resultant Drum Tulip product. The cut away kneecap and knuckle portions can be directed downwardly into collection or storage containers, while the Drum Tulip products are further conveyed to the discharge of the apparatus whereupon each Drum Tulip product will be disengaged from its drum holding assembly for collection as the empty drum holding assemblies continue along a return portion of the conveyer back toward the loading area.

The aspects and embodiments described above, as well as further or other aspects, features, embodiments, options, and advantages of the present disclosure will be further explained in detail with reference to the accompanied drawings as described below. It further will be appreciated that any of the aspects, features, advantages, and options described with respect to any of the methods disclosed herein apply equally to the apparatus of the present disclosure, and vice versa, it further will be clear that any one or more of the aspects, features and/or options discussed herein can be combined.

### BRIEF DESCRIPTION OF DRAWINGS

It will be appreciated that for simplicity and clarity of illustration, elements illustrated in the figures have not necessarily been drawn to scale. For example, dimensions of some of the elements may be exaggerated relative to other elements. Examples incorporating the principles of the present disclosure are shown and described with respect to the drawings and are provided by way of non-limiting illustration. It is further noted that the figures include dramatic illustrations of the present disclosure, in which:

FIG. 1A is a perspective view of an apparatus for processing animal parts, including formation of poultry Drum Tulip products, according to principles of the present disclosure.

FIG. 1B is a perspective view taken from rear or opposite side of the apparatus for processing animal parts of FIG. 1A.

FIG. 2 is a perspective end view of the apparatus for processing animal parts of FIGS. 1A-1B, taken from the distal or discharge end thereof.

FIG. 3A is a schematic illustration on an embodiment of a conveyer having a plurality of drum holding assemblies for an apparatus for processing animal parts according to the principles of the present disclosure.

FIG. 3B is an illustration of one of the drum holding assemblies of FIG. 3A.

FIGS. 4A and 4B illustrate examples of animal leg or drum parts before and after cutting so as to form a Drum Tulip product.

FIG. 5A is a perspective side view illustrating an embodiment of a safety arm sensor arrangement, cutting area, and discharge end of the apparatus for processing animal parts according to the principles of the present disclosure.

FIG. 5B illustrates an embodiment of a front guide of the apparatus for processing animal parts according to the principles of the present disclosure.

FIG. 6 is a perspective view of an embodiment of the apparatus for processing animal parts of FIGS. 1A-2 and 5A.

FIGS. 7A and 7B illustrate portions of the front guide for directing the animal leg or drum parts toward a scraper and for cutting.

FIG. 8 is a perspective view illustrating the discharge end of the of the apparatus for processing animal parts, including formation of Drum Tulip products, according to the principles of the present disclosure.

### DETAILED DESCRIPTION

So that the manner in which the features and advantages of the embodiments of the systems and methods disclosed herein, as well as others that will become apparent, may be understood in more detail, a more particular description of embodiments of systems and methods briefly summarized above may be had by reference to the following detailed description of embodiments thereof, in which one or more are further illustrated in the appended drawings, which form a part of this specification. It is to be noted, however, that the drawings illustrate only various embodiments of the systems and methods disclosed herein and are therefore not to be considered limiting of the scope of the systems and methods disclosed herein as it may include other effective embodiments as well.

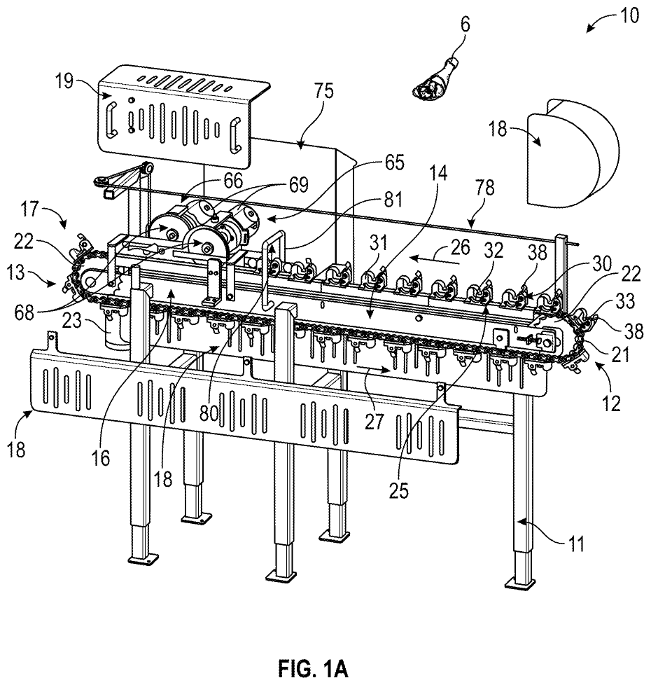

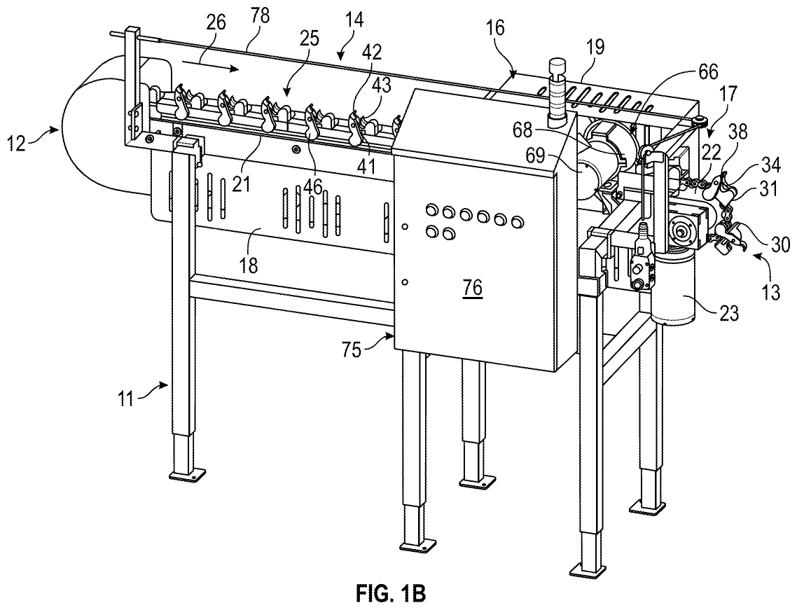

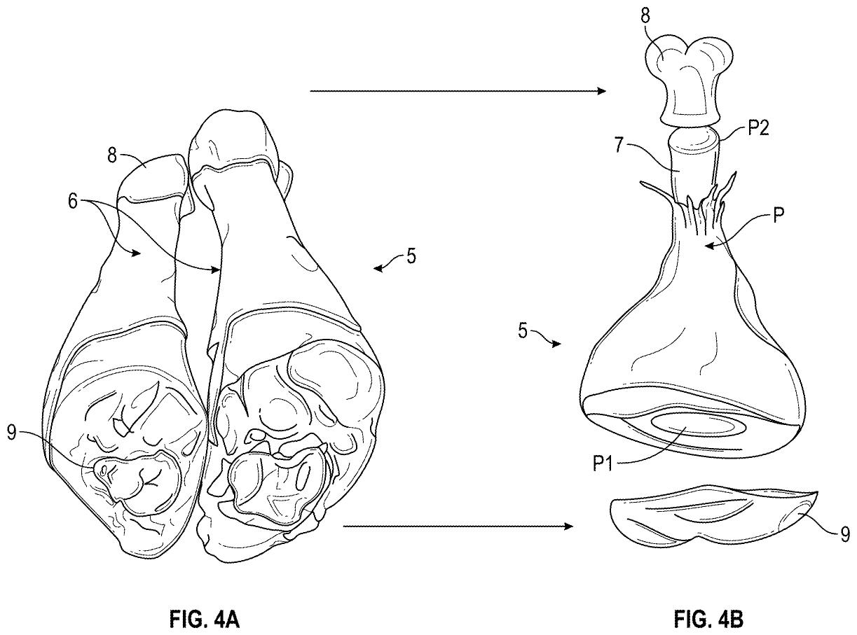

Referring now to the drawing figures, FIGS. 1A-3B and 5-8 illustrate an apparatus 10 for processing animal parts according to embodiments of the present disclosure. As illustrated in FIGS. 4A-4B, the animal parts can include parts of poultry (e.g., chicken, turkey, etc.), and, in particular, in example embodiments as illustrated in the present disclosure, can include leg or drum parts 5 of poultry, which leg or drum parts 5 generally can include a drumstick portion 6, a leg bone 7 including a knuckle or hock end 8 and a kneecap end 9, with meat surrounding the leg bone 7. It will further be understood by those skilled in the art that the principles of the present disclosure also can be applied to the processing of other types of animal parts. As illustrated in FIG. 4B, after processing through the apparatus 10, the leg or drum part 5 will have at least a portion of the knuckle or hock end 8 of the leg bone 7 removed, as well as at least a portion of the kneecap end 9 thereof, to form a resultant “Drum Tulip” product P (e.g., a cut product P) having a flattened end P1 and a handle portion P2.

As generally illustrated in FIGS. 1A-2 and 5A, in embodiments, the apparatus 10 generally will include a frame 11 having a first, proximal or upstream end 12, and a second, distal or downstream end 13. The frame can be configured with at least one loading station or area 14 defined therealong adjacent the proximal or upstream end 12 of the frame 11, a cutting station or area 16 downstream from the loading area 14, and a discharge 17 located at the downstream, distal or second end 13 of the frame 11.

In addition, in embodiments, the frame 11 can be extended so as to provide the loading station 14 with multiple loading positions as needed. For example, in some embodiments, the frame 11 can be extended so as to provide two, three or more loading stations wherein multiple workers can load a series of legs or drums 5 into the apparatus 10 for processing, with sufficient spacing provided between each loading position.

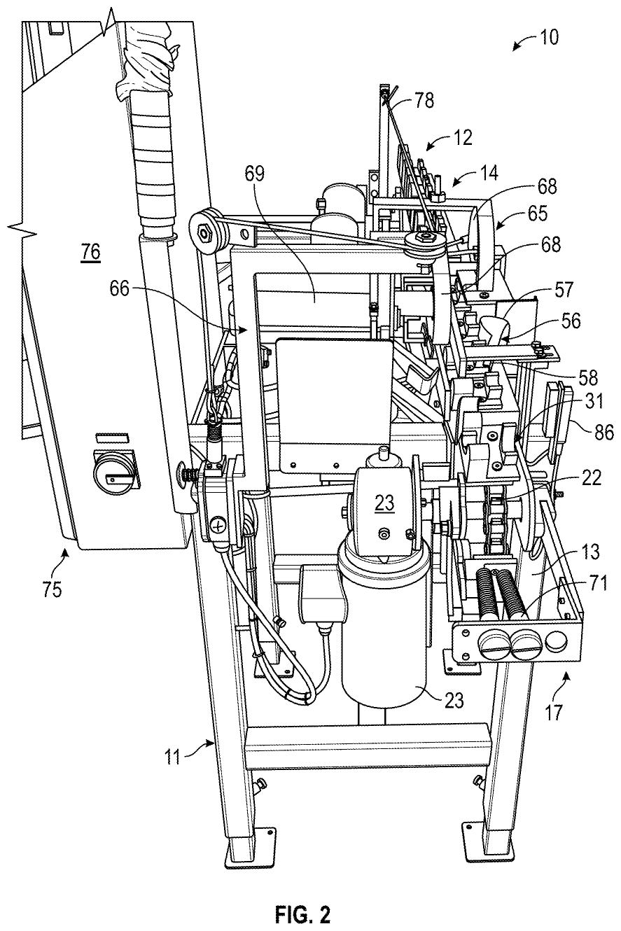

As further generally illustrated in FIGS. 1A-2, in embodiments, a series of covers or guards 18 generally can be arranged along the frame 11 to substantially prevent inadvertent access to various operative components of the apparatus 10. For example, a removable blade cover 19 can be provided along the cutting area or station 16 to substantially enclose and prevent access to cutting assemblies of the cutting area. Additional covers or guards 18 also can be provided.

As further illustrated in FIGS. 1A-2, a conveyor 21 is located along the frame 11, extending between the first, proximal or upstream end 12 and the second, distal or downstream end 13 thereof. While the conveyor 21 is shown as a chain conveyor, it further will be understood by those skilled in the art that other types of conveying systems, including belt conveyors, also can be used. The conveyor 21 will be extended about a pair of sprockets or gears 22, one or both of which can be driven by a motor 23 (e.g., as illustrated in FIGS. 1A-2, wherein a motor 23 is located at the second, distal or downstream end 13 of the frame 11), and will convey a series of drum holding assemblies 25 along a processing path 26 for loading of the leg or drum parts 5 in each of the drum holding assemblies 25, and then passing the leg or drum parts 5 through the cutting area or station 16 for cutting, and to the discharge 17 wherein the Drum Tulip products P are discharged from each of the drum holding assemblies. After unloading, the drum holding assemblies 25 will be moved along a return path 27 (e.g., along the lower portion of the conveyor 21) back to the loading area or station 14 for continued use.

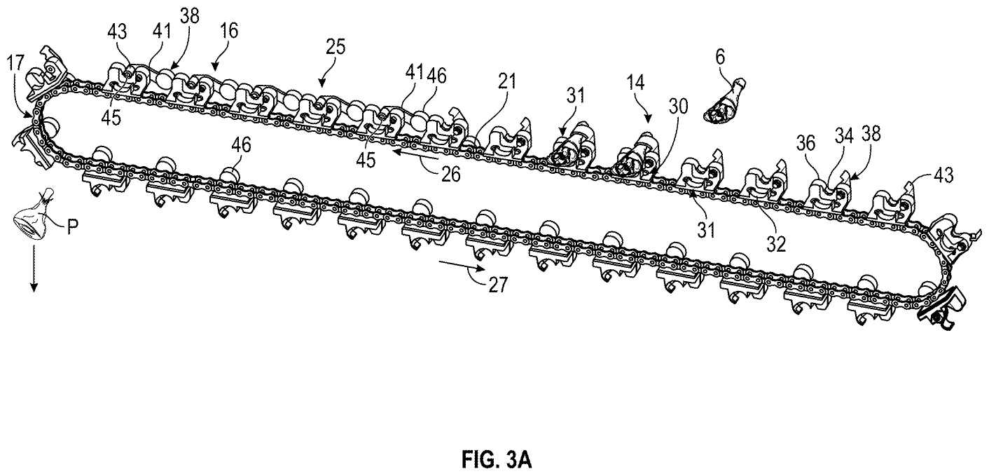

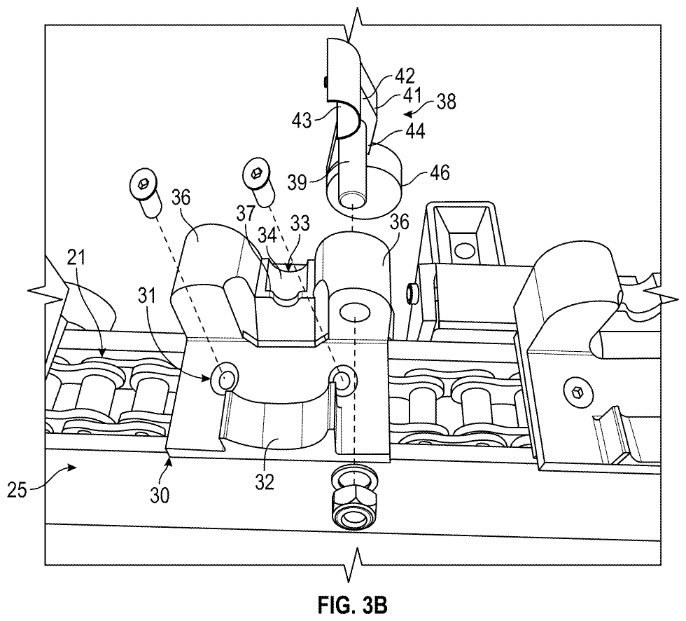

As illustrated in FIGS. 3A-3B, 5A, and 8, in embodiments, each of the drum holding assemblies 25 generally will include a base or carriage 30 formed from a rigid, durable material, such as various plastic materials, metals such as stainless steel, or other materials, and which will be secured to one or more links of the chain of the conveyor 21. The base or carriage 30 of each drum holding assembly 25 generally can define a cradle 31 (FIG. 3B) that can have a seat or rest portion 32 along a first or front side thereof, and a clamping recess 33 on the second or rear side thereof.

In embodiments, the seat portion 32 generally is configured to receive and support a portion of the drumstick 6 of the leg or drum part 5 adjacent the kneecap end 9 thereof, while the clamping recess 33 can be configured to receive and contain a portion of the leg or drum part 5 adjacent its hock end or knuckle 8. For example, in an embodiment such as shown in FIG. 3B, the clamping recess 33 can include generally semi-circular depression 34, between raised side portions 36 and further can include a rib or projection 37 along the depression 34, this rib or projection 37 can help hold and strip meat from a leg or drum part 5 when the leg or drum part is engaged in a clamped engagement within its associated or corresponding drum holding assembly 25.

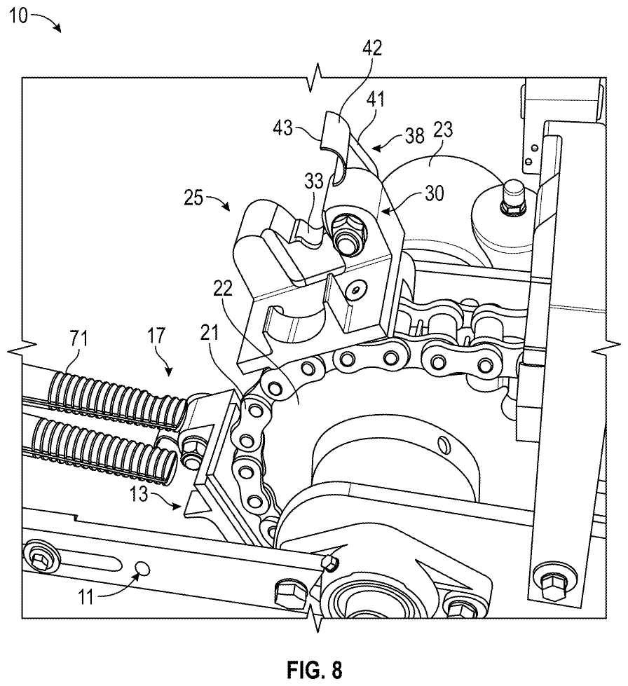

As further generally illustrated in FIGS. 3B and 8, each of the drum holding assemblies 25 will include a pivoting clamp arm 38 attached to base 30 adjacent one of the raised side portions 36 adjacent the clamping recess 33, such as via a pin or a fastener 39. The clamp arm 38 includes a body 41 having a first or proximate end 42 including a generally semi-circular clamping portion 43, and a second or distal end 44 that include a cam 46, such as a cylinder or other enlarged portion formed or attached at the distal end 44 of the body 41 of clamp arm 38. The clamping portion 43 of the clamp arm 38 can be configured with a generally opposed, cooperative configuration to the clamping recess 33 of the base 30 such that when the clamp arm 38 is in its lowered position, the clamping portion 43 is placed over the clamping recess 33 of the base 30 so as to define a meat-stripping passage 45 (FIGS. 3A, 5A, and 7A). As indicated in FIG. 3A, a portion of the leg or drum part 5 is received and extends through the meat-stripping passage 45 as the leg or drum part 5 is moved along the processing path 26 from the loading station or area 14 through the downstream cutting area or station 16 with the forward movement of the conveyor 21.

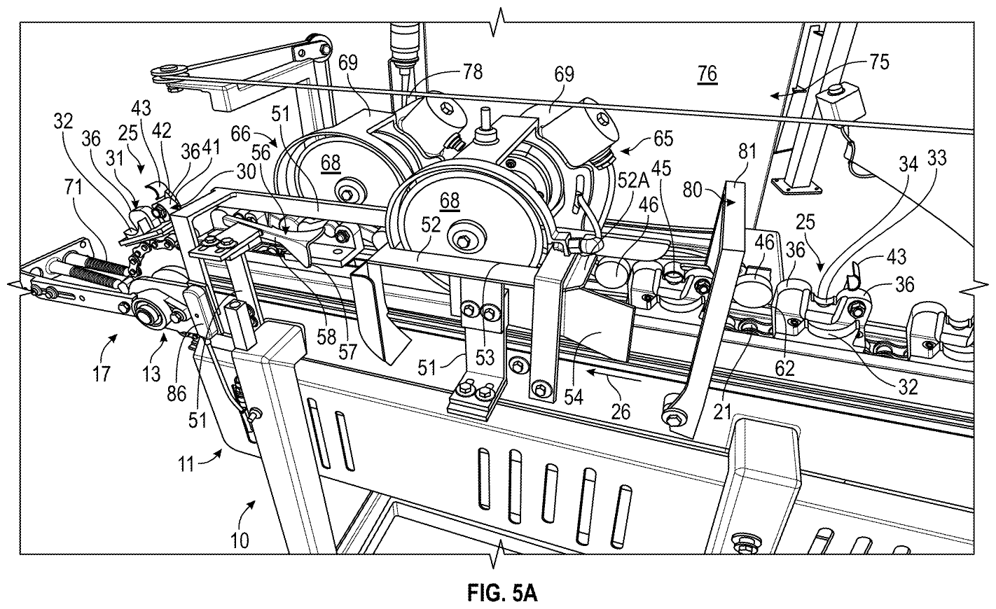

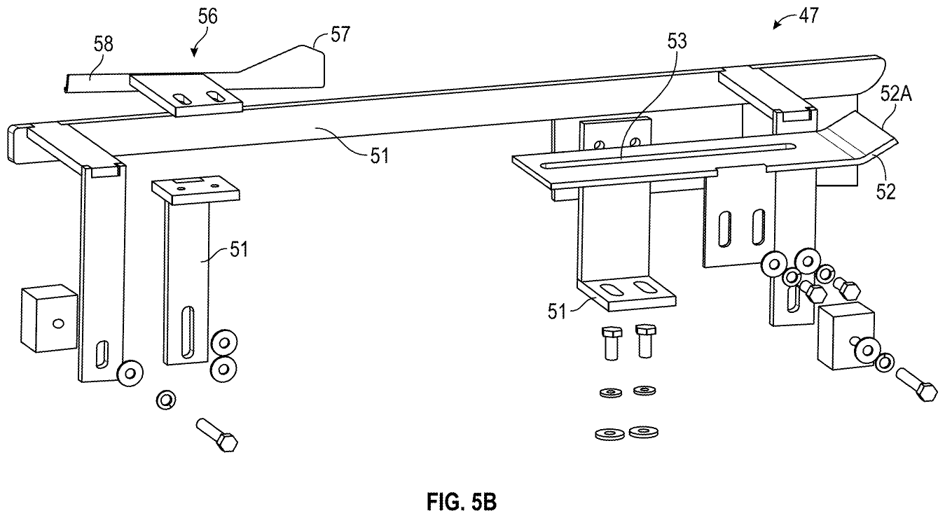

As generally illustrated in FIGS. 5A and 5B, front and rear guides 47 and 48 are located along the conveyor 21. The front and rear guides will be arranged along the processing path 26 such that as the leg or drum parts 5 are moved into and through the cutting station or area 16 by their drum holding assemblies 25, the cams 46 of the clamp arms 38 of each of the drum holding assemblies 25 will be moved to a clamping position to hold the hock ends 8 of each leg or drum part 5, with the drumsticks 6 each of the leg or drum parts 5 supported adjacent at their kneecaps 9 so as to align the kneecaps, or at least a portion thereof, for separation and removal of the portion of the kneecap.

As illustrated in FIG. 5B, the front guide 47 includes a frame 51 with a series of guide plates, including, for example, a plate or blade guide 52 that can have a blade guide slot or opening 53 defined therealong. The blade guide 52 also can have an upwardly flared forward end 52A that, together with a lower guide plate 54, can help guide the kneecap 9 into a desired alignment or position for cutting away of at least a portion of the kneecap 9.

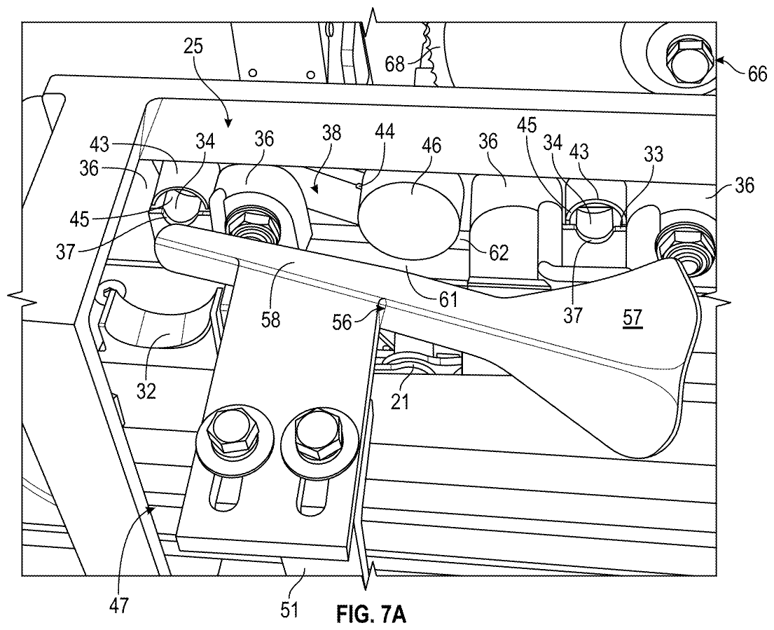

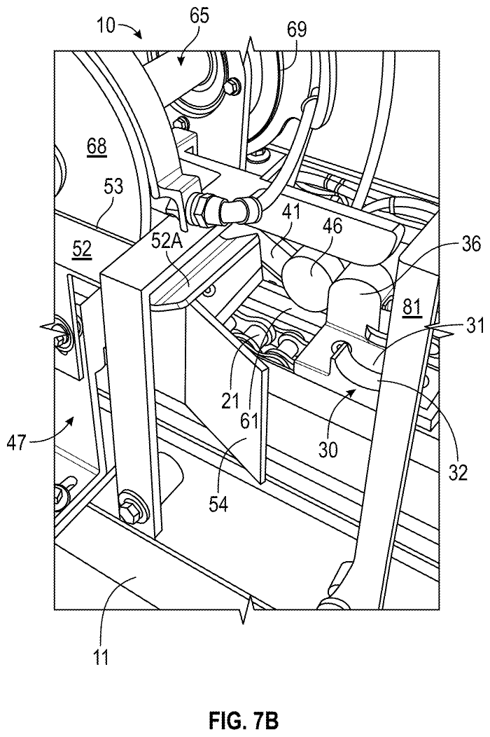

As illustrated in FIGS. 5A-5B and 7A, the front guide 47 also can include a meat scraper 56, which can be formed as a plate or bracket having a flared forward end 57 configured to receive and help guide the now cut kneecap end P1 of the leg or drum part 5 into engagement with an angled body portion 58 that extends forwardly and across the processing path 26 and the conveyor 21. The meat scraper 56 will guide and urge the leg bone 7 of each leg or drum part 5 in a generally transverse direction across the processing path 26 as the leg or drum part 5 continues its forward movement, carried by the conveyor 21. As a result, the leg bone 7 of each leg or drum part 5 is urged through the meat-stripping passage 45 defined between the clamping portion 43 of the clamp arm 38 and the clamping recess 33 of the base 30 of its drum holding assembly 25 so as to position the knuckle or hock end 8 of the leg bone 7 for cutting away of at least a portion of the knuckle 8. At the same time, the edges of the clamping portion 43 of the clamp arm 38 and the rib 37 of the clamping recess 33 generally will scrape and urge or hold back a portion of the meat along the drumstick portion 6 of the leg or drum part 5, which can define a handle or holding portion P2 for the Drum Tulip product P as shown in FIG. 4B.

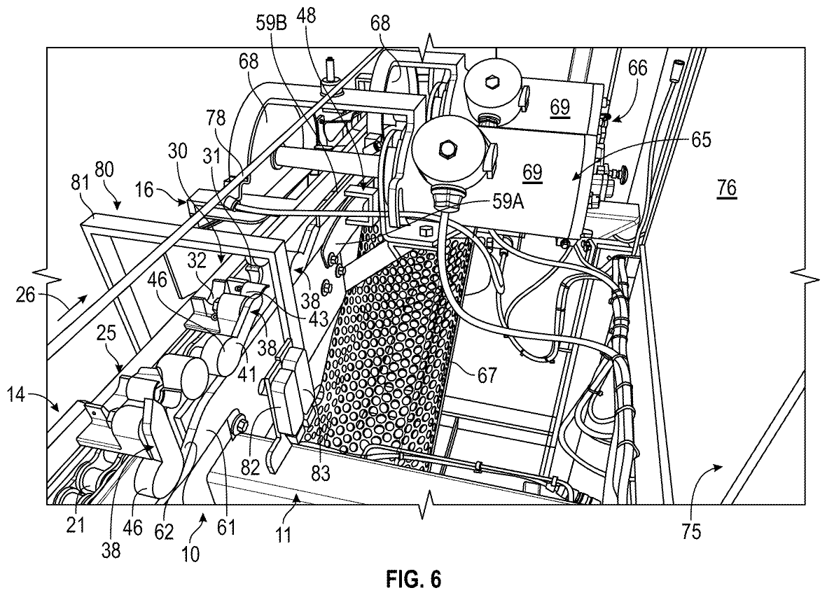

As illustrated in FIG. 6, the rear guide 48 includes a series of guide plates, including first and second knuckle guide plates 59A and 59B positioned along the processing path, and which can define a passage or panel along which the hock ends or knuckle portions 8 of the leg or drum parts 5 will be passed for cutting at least of a portion of the knuckles 8 from the leg bones 7 thereof. The rear guide 48 further will include a ramp or cam plate 61 having a sloped, upwardly extending cam surface 62 at an upstream or first end thereof.

As indicated in FIGS. 5A and 6-7B as the drum holding assemblies 25 are moved along the processing path 26 with the forward movement of the conveyor 21, the cams 46 of the clamp arms 38 of each of the drum holding assemblies 25 will be carried into engagement with the sloping cam surface 62 of the ramp or cam plate 61. As the cams 46 side along the cam surface 62, the clamp arms 38 are caused to pivot so that the clamping portion 43 of each clamp arm is generally rotated downwardly toward its clamping position so as to capture and hold the leg bone 7 of the leg or drum part 5 loaded within its drum holding assembly 25 as the leg or drum part 5 is conveyed into the cutting area or station 16 of the apparatus 10.

As generally illustrated in FIGS. 1A-2, in embodiments, the cutting station or area 16 of the apparatus 10 generally can include first and second cutting assemblies 65 and 66. The first cutting assembly 65 generally will be positioned upstream of the second cutting assembly 66, and will be arranged or located along the processing path 26 for cutting away the kneecaps 9, or at least a portion thereof, from each of the leg or drum parts 5. The second cutting assembly 66 generally will be located downstream from the first cutting assembly 65 and along on opposite side of the conveyor 21 and processing path 26. The second cutting assembly 66 generally will be arranged or located so as to engage and cut away the knuckle portion 8 of each leg or drum part 5.

As further illustrated in FIG. 6, when the knuckle portions 8 of the leg or drum parts 5 are cut away, they can be dropped to a chute or slide 67 that can direct them into a container, etc. for disposal. Similarly, the kneecap portions 9 cut away from each of the leg or drum parts 5 can be dropped into a container or otherwise directed away from the cutting station or area 16 for disposal for storage and disposal.

Each of the first and second cutting assemblies 65 and 66 (FIGS. 1A, 2, 5A and 6) generally can include a rotary cutting blade 68 that will be driven by a drive motor 69. Other types of cutting assemblies or cutting mechanisms also can be used. As indicated in FIG. 5A, the cutting blade 68 of the first cutting assembly can be received within the blade guide opening 53 of the blade guide plate 52, and will be operable to cut away the kneecap portion 9 from the leg or drum parts 5. The cutting blade 68 of the second or downstream cutting assembly 66 can include a slotted or notched cutting blade adapted for cutting away bone, and will be positioned to engage the leg bone 7 of each leg or drum part 5 after the leg or drum parts 5 have been further extended or urged through the meat stripping passages 41 defined by each of the drum holding assemblies 25, to cut away the knuckle portions 8 thereof as illustrated in FIG. 4B.

In embodiments, as the drum holding assemblies 25 are conveyed out of the cutting area or station 16, the cams 46 of the clamp arms 38 will be released from engagement with the cam surface 62 of the ramp or cam plate 61, causing the clamping portions 43 of the clamp arms 38 thereof to be pivoted or moved to an open position as the drum holding assemblies move to the discharge end 13 of the frame 11 (FIG. 8) so as to release each Drum Tulip product P from engagement within its associated drum holding assemblies 25. For example, the clamp arms 38 can be biased to the open position, such as by a spring, and/or another cam surface can urge the cams 46 downwardly after the cams 46 disengage from the cam surface 62. As the drum holding assemblies 25 further continue along and about the drive sprocket 22 of the second, downstream or distal end 13 of the frame 11 of the apparatus 10, the Drum Tulip products P can fall away into a collection bin or other container as the drum holding assemblies 25 turn and proceed along their return path 27.

In addition, fingers or scrapers 71 (FIGS. 2, 5A, and 8) also can be provided adjacent the discharge 17 so as to help dislodge the Drum Tulip products P from the drum holding assemblies 25 as needed. Such fingers or scrapers 71 generally can include flexible rods, fingers, tubes, or other, similar types of features, adapted to urge the Drum Tulip products P out of the drum holding assemblies 25, without damaging the meat thereof.

As illustrated in FIGS. 1A-2, the apparatus 10 can further generally include a control 75, which can be mounted in a control cabinet 76 arranged along the rear portion of the apparatus 10. The controller 75 generally will include one or more processors having programming configured to monitor and control various operative elements of the apparatus, including control of the motors for driving operation of conveyor 21, and the motors for the first and second cutting assemblies 65 and 66. In embodiments, the controller 75 also can be linked to a centralized server or controller for a plant or facility at which the apparatus is being used, and, in some embodiments, further can include an operator interface or controls. The controller 75 further can be in communication with a series of sensors arranged at various locations along the apparatus 10, and which can send control signals in the event of jamming or misfeeding of the leg or drum parts 5, upon removal of protective covers, or upon other fault conditions being detected.

For example, as illustrated in FIGS. 1A-2 and 5A, in some embodiments, a safety line or pull cord 78 can be provided, e.g. extending along the length of the frame, and if triggered, can signal the controller 75 to initiate an emergency stop of all operations of the apparatus 10.

In addition, in embodiments, as generally illustrated in FIGS. 5A and 6, a safety arm fitting 80 can be provided along the processing path, upstream of the cutting area or station 16, and can include an arm or bracket 81 that is pivotally mounted to the frame 11. A magnetic sensor 82, or other type of sensor, can be mounted to the frame, with a corresponding magnetic contact or sensor 83 mounted to the pivoting safety arm. When the safety arm 81 is engaged or otherwise caused to pivot and move such that the contact between the magnetic sensors 82, 83 is broken, a signal will be sent to the controller 75, which can initiate a stop of operation of the apparatus 10, e.g., shutdown of the motors 69 operating the cutting blades 68 of the cutting assemblies 65, 66 and/or stopping operation of the conveyor 21, and further can provide an alert, such as a warning light or alarm, to an operator.

In addition, as indicated in FIGS. 2, 5A, and 6, sensors can be placed along the guards or covers mounted to the frame. For example, a sensor 86 can be mounted to the blade cover 19 to indicate removal of the blade cover, which generally can prevent any further operation of the apparatus 10. The sensor 86 can include a magnetic sensor, similar to the magnetic sensors of the safety arm 81, or other similar type of sensor or detector.

According to one embodiment, during operation of the apparatus 10, one or more workers or operators can load a series of leg or drum parts 5 into each of the drum holding assemblies 25 as they are conveyed along the length of the frame 11. As the drum holding assemblies 25 move along their processing path 26 out of the loading station or area 14 and toward the cutting station or area 16, the cams 46 of their clamp arms 38 will engage and ride along the sloped cam surface 62 of the ramp or cam plate 61 of the rear guide 48. This can cause the clamp arm 38 to be pivoted toward a closed, clamping position, wherein the clamping portion 43 thereof is positioned over and engages and clamps the leg bone 7 of the leg or drum part 5 held within its associated drum holding assembly 25 against the clamping recess 33 thereof. As the leg or drum parts 5 continue along their processing path 26 and into the cutting station 16, the first cutting assembly 65 will engage and cut away at least a portion of the kneecap 9 of each of the leg or drum parts 5, which kneecap portion 9 can fall away for collection.

After the kneecap portion 9 is cut away, the leg or drum parts 5 are moved into engagement with the meat scraper 56 of the front guide 47, causing each leg or drum part 5 to be urged in a generally transverse direction across the processing path 26 as the drum or leg parts 5 are further moved forwardly along the processing path 26. As a result, the leg bone 7 of each leg or drum part 5 is moved through the meat-stripping passage 45 defined between the clamping portion 43 of the clamp arm 38 and the clamping recess 33 of the base 30 of the drum holding assembly 25 to position or locate the hock end 8 of the leg bone 7 in alignment or position for cutting away of the knuckle portion 8 of the leg bone 7. At the same time, at least a portion of the meat along the hock end 8 of the leg bone 7 will be engaged and scraped or urged rearwardly along the leg bone 7 such that once the knuckle portion 8 is cut away from the leg bone 7, a Drum Tulip product P is formed, having a substantially flattened base or bottom end P1 adjacent where the kneecap 9 was located, and also will have a handle portion defined by an extended, scraped portion of the leg bone 7 as generally illustrated in FIG. 4B.

In the drawings and specification, several embodiments of systems and methods to provide Drum Tulip products from cutting animal parts have been disclosed, and although specific terms are employed, the terms are used in a descriptive sense only and not for purposes of limitation. Embodiments of systems and methods have been described in considerable detail with specific reference to the illustrated embodiments. However, it will be apparent that various modifications and changes can be made within the spirit and scope of the embodiments of systems and methods as described in the foregoing specification, and such modifications and changes are to be considered equivalents and part of this disclosure.

1. An apparatus for processing animal parts, comprising:
a frame;
a conveyer supported along the frame and configured to move along a processing path;
a series of drum holder assemblies arranged at spaced intervals along the conveyor, each of the drum holder assemblies configured to receive and carry a poultry leg or drum part of a plurality of leg or drum parts along the processing path from a loading area through a cutting station;
wherein the cutting station is configured to separate a kneecap portion and at least a portion of a knuckle from each of the leg or drum parts to form a cut product as the leg or drum parts are moved along the processing path through the cutting station; and
a discharge station positioned downstream from the cutting station and configured to discharge the cut products from the respective drum holder assemblies.

2. The apparatus of claim 1, wherein each of the drum holder assemblies comprises a base having a cradle configured to support at least a portion of a leg or drum part received therein, and a clamping recess for receiving at least a portion of the leg or drum part proximate the knuckle of the respective leg or drum part.

3. The apparatus of claim 2, wherein each of the drum holder assemblies further comprises a clamp arm pivotably mounted to the base, the clamp arm having a clamping portion adapted to fit over and cooperatively engage with the clamping recess of the base for holding the leg or drum part as it is moved along the processing path at least through the cutting station.

4. The apparatus of claim 3, wherein the clamping portion of the clamp arm and the clamping recess of the base cooperate to at least partially define a meat-stripping passage.

5. The apparatus of claim 1, wherein each of the drum holder assemblies comprises a base and a clamp arm mounted to the base, the clamp arm having a clamping portion at a first end of the clamp arm and a cam at a second end of the clamp arm; wherein the cam is configured to engage a cam surface located along at least a portion of the cutting station such that the clamp arm is caused to pivot toward engagement with the leg or drum part supported by the base when the cam engages the cam surface.

6. The apparatus of claim 5, wherein the clamping portion of the clamp arm is moved over a clamping recess defined on the base for holding the leg or drum part therebetween when the cam engages the cam surface.

7. The apparatus of claim 1, wherein the cutting station comprises a first cutting blade and a second cutting blade mounted on opposite sides of the conveyor, the first cutting blade being positioned to cut the kneecap portion of each of the leg or drum parts as they are moved on the respective drum holder assemblies by the conveyor in the cutting station, and the second cutting blade being positioned to cut the knuckle of each of the leg or drum parts as they are moved on the respective drum holder assemblies by the conveyor along the cutting station.

8. The apparatus of claim 1, further comprising a blade guide mounted relative to a first cutting blade of the cutting station for engaging the kneecap portions of the leg or drum parts and at least partially aligning the kneecap portions with the first cutting blade as the leg or drum parts are moved on the respective drum holder assemblies by the conveyor along the cutting station.

9. The apparatus of claim 8, further comprising a knuckle guide plate mounted relative to a second cutting blade of the cutting station for engaging the knuckles of the leg or drum parts and at least partially aligning the knuckles with the second cutting blade as the leg or drum parts are moved on the respective drum holder assemblies by the conveyor along the cutting station.

10. The apparatus of claim 1, further comprising a meat scraper positioned along at least a portion of the cutting station and each of the drum holder assemblies at least partially defines a meat-stripping passage, wherein the meat scraper comprises a bracket having a flared forward end and is adapted to guide a leg bone of each of the leg or drum parts across the processing path and through the respective meat-stripping passage for moving the leg bone relative to a meat portion of the respective leg or drum parts as the leg or drum parts are moved through the cutting station.

11. A method of processing animal parts, the method comprising:
moving a series of drum holder assemblies along a processing path, each of the drum holder assemblies supporting a respective poultry leg or drum part of a plurality of leg or drum parts along at least a portion of the processing path;
cutting the leg or drum parts to separate a kneecap portion and at least a portion of a knuckle from each of the leg or drum parts to form a drum tulip product while moving the leg or drum parts along the processing path on the respective drum holder assemblies; and
discharging the drum tulip products from the respective drum holder assemblies at a downstream end of the processing path.

12. The method of claim 11, wherein each of the drum holder assemblies comprises a base having a clamping recess configured to support at least a portion of the respective leg or drum part and a clamp arm pivotably mounted to the base, the clamp arm having a clamping portion, wherein the method further comprises pivoting the clamp arm of each of the drum holder assemblies while moving the respective drum holder assemblies along a portion of the processing path to move the clamping portion over the clamping recess so that the clamping portion and the clamping recess cooperate to hold the leg or drum part therebetween prior to the cutting the leg or drum parts.

13. The method of claim 12, wherein, for each of the drum holder assemblies, the clamping portion is at a first end of the clamp arm, the clamp arm comprises a cam at a second end of the clamp arm, and wherein the pivoting the clamp arm of each of the drum holder assemblies comprises engaging the cam with a cam surface positioned along the path of travel so that the cam surface moves the cam to pivot the clamping portion toward the clamping recess of the base as the drum holder assemblies are moved along the portion of the processing path.

14. The method of claim 12, wherein discharging the drum tulip products comprises pivoting the clamp arm to move the clamping portion away from the clamping recess of the base of each drum holder assembly and releasing the leg or drum part from the drum holder assembly as the conveyor conveys the drum holder assemblies through a discharge.

15. The method of claim 11, wherein cutting the leg or drum parts comprises cutting the kneecap portion of each of the leg or drum parts with a first cutting blade and cutting the knuckle of each of the leg or drum parts with a second cutting blade mounted on an opposite side the processing path from the first cutting blade as the leg or drum parts are moved on the respective drum holder assemblies along the processing path past the first cutting blade and the second cutting blade.

16. The method of claim 15, wherein cutting the kneecap portion of each of the leg or drum parts comprises engaging the kneecap portion with a blade guide mounted relative to the first cutting blade to at least partially align the kneecap portions with the first cutting blade.

17. The method of claim 16, wherein the cutting the knuckle of each of the leg or drum parts comprises engaging the knuckle with a knuckle guide mounted relative to the second cutting blade to at least partially align the knuckle with the second cutting blade.

18. The method of claim 15, further comprising moving at least a leg bone of each of the leg or drum parts across the processing path at least partially through a meat-stripping passage of the respective drum holder assembly by engaging the respective leg or drum part with a bracket of a meat scraper so that a leg bone of the respective leg or drum part is moved relative to a meat portion of the leg or drum parts.

19. An apparatus for processing animal parts, comprising:
a series of drum holder assemblies moved along a processing path, each of the drum holder assemblies comprising a base and a clamp arm mounted to the base, wherein each of the bases is configured to receive and carry a poultry leg or drum part of a plurality of leg or drum parts along the processing path, and wherein the clamp arm is pivotable to a position for cooperating with the base to hold the leg or drum part as it is moved along at least a portion of the processing path;
a cutting assembly comprising a cutting blade mounted along the processing path for separating an end of each of the leg or drum parts as they are moved past the cutting blade on the respective drum holder assemblies; and
a meat scraper adapted to move at least a portion of each of the leg or drum parts across the processing path as they are moved along a portion of the processing path on the respective drum holder assemblies.

20. The apparatus of claim 19, wherein the cutting assembly is a first cutting assembly and the cutting blade is a first cutting blade positioned along a first side of the processing path, wherein the apparatus further comprises a second cutting assembly with a second cutting blade positioned on a second side of the processing path opposite to the first side for separating an opposing end of each of the leg or drum parts as they are moved past the second cutting blade on the respective drum holder assemblies, and wherein the meat scraper is located downstream from at least one of the first cutting blade and the second cutting blade.

21. The apparatus of claim 19, wherein each of the drum holder assemblies at least partially defines a meat-stripping passage, wherein the meat scraper is adapted to guide a leg bone of each of the leg or drum parts across the processing path and through the respective meat-stripping passage for moving the leg bone relative to a meat portion of the respective leg or drum parts as the leg or drum parts are moved along a portion of the processing path.
